(19) United States
(12) Patent Application Publication
(10) Pub. No.: US 2021/0376612 A1
(43) Pub. Date: Dec. 2, 2021

(54) SMART ENERGY MANAGEMENT SYSTEMS AND METHODS FOR POWER SYSTEM RESILIENCY

(71) Applicant: University of Florida Research Foundation, Incorporated, Gainesville, FL (US)

(72) Inventor: Prabir Barooah, Gainesville, FL (US)

(21) Appl. No.: 17/328,921

(22) Filed: May 24, 2021

Related U.S. Application Data
(60) Provisional application No. 63/029,806, filed on May 26, 2020.

(51) Int. Cl. H02J 3/38; H02J 13/00; G05B 13/04

(52) U.S. Cl. CPC H02J 3/381; H02J 13/00002; H02J 2203/20; G05B 13/042; H02J 2300/24; G05B 13/048

(57) ABSTRACT

Systems and methods are configured to managing and controlling an energy system comprising at least one primary energy load, at least one secondary energy load, and an energy storage subsystem configured to receive energy from an energy source and provide energy to the energy loads. In embodiments, a method is provided. The method includes receiving a first system state data object associated with a first timepoint, generating a second system state data object associated with a second timepoint, determining control commands for each of the at least one primary energy load, the at least one secondary energy load, and the energy storage subsystem based at least in part on evaluating the second system state data object in a constrained optimization model, and causing energy to be supplied at the second timepoint to the energy loads and/or the energy storage subsystem based at least in part on the control commands.

### CROSS REFERENCE PARAGRAPH

This application claims priority to U.S. Prov. Appl. No. 63/029,806 filed May 26, 2020, the contents of which is hereby incorporated in its entirety by reference.

### GOVERNMENT SUPPORT

This invention was made with Government support under 1646229 awarded by the National Science Foundation. The government has certain rights in the invention.

### TECHNOLOGICAL FIELD

Embodiments of the present disclosure generally relate to systems and methods used in providing resiliency of a limited power supply in an environment.

### BACKGROUND

Extreme climate events are becoming more common the world over. In the United States, hurricanes, heat waves, and forest fires are occurring with increasing frequency. Among the many consequences of these natural disasters is the loss of electricity supply for long periods. A few recent examples include 4.8 millions of utility customers who lose electricity in Florida after hurricane Irma, with 1.5 million remaining without electricity for five days or more, and the months-long blackout in Puerto Rico after hurricane Maria, leading to an estimated death toll in the thousands. Thus, the need for resiliency of power supply is critical, especially when a disaster occurs and such supply is limited.

Distributed solar generation can provide a resilient power supply since the sky is often clear immediately after a disaster such as a hurricane. For instance, rooftop solar photovoltaic (PV) panels together with batteries can provide such resiliency. However, solar generation equipment has limits on the amount of energy the system can supply at any given time based at least in part on the number of panels making up the system and the size of the battery. As the average household load in the United States is quite high 30.5 kWh/day, serving the entire energy requirements for a household from an on-site PV and battery system normally requires a large system to provide meaningful resiliency, driving up cost substantially. The same can be true for other limited power supplies such as a gas-powered generator that may be used to power a home after an outage. Therefore, a need exists in the industry for intelligent decision makers that can operate limited power supplies to ensure that critical energy loads are serviced to the maximum duration possible. It is with respect to these considerations and others that the disclosure herein is presented.

### BRIEF SUMMARY

In general, embodiments of the present disclosure provide methods, apparatus, systems, computing devices, computing entities, and/or the like for managing and controlling an energy system comprising at least one primary energy load, at least one secondary energy load, an energy storage subsystem, and at least one energy source. In various embodiments, the at least one energy source is a solar photovoltaic energy source configured to provide energy to the energy storage subsystem for storage based at least in part on solar irradiance. In various embodiments, managing and controlling the energy system comprises evaluating various state data values in an optimization model.

Specifically, a constrained optimization model is evaluated in various embodiments to determine one or more control commands for controlling the energy loads (e.g., at least one primary energy load, at least one secondary energy load) and the energy storage subsystem to achieve one or more objectives with respect to one or more constraints. The constraints may be based at least in part on one or more estimated values with respect to the objectives at the future time, current energy usage for the energy loads, an estimated energy level for the limited power supply at the future time, a current energy level for the limited power supply, and/or a current value for each of the control commands. For example, an objective may be maximization of operation time of a primary energy load, which is based at least in part on energy being supplied to the primary energy load, while a constraint may be a maximum amount of energy available in the energy storage subsystem. In various embodiments, the optimization model determines the one or more control commands using a cost function.

Accordingly, one or more control commands are determined based at least in part on evaluating the optimization model to achieve at least one of the objectives at the future time. Based at least in part on the one or more control commands, energy is provided by the energy storage subsystem to the energy loads, and charging and/or discharging of the energy storage subsystem is performed at the future time. For example, the constrained optimization problem may be formulated as a mixed integer linear program (MILP), and each of the control commands set for the energy loads may be an integer value indicating an on or off state with respect to providing energy to a particular energy load. Further, the control commands may include a control command in particular embodiments indicating whether charging of the limited power supply is performed in a fast mode or a normal mode.

Methods and operations of various embodiments of the present disclosure may be performed continuously in one or more successive iterations. In various embodiments, one or more successive iterations may be performed with respect to evaluating the optimization model and determining one or more control commands until an external energy source has been restored to provide energy to the energy system (e.g., primary and secondary energy loads, energy storage subsystem).

In accordance with an aspect of the present disclosure, a computer-implemented method is provided. In one embodiment, the computer-implemented method includes receiving a first system state data object (i) associated with a first timepoint, and (ii) including a first primary energy load state data value and a first energy storage subsystem state data value. In various embodiments, the computer-implemented method further includes receiving a solar irradiance prediction data object associated with a second timepoint subsequent to the first timepoint. In various embodiments, the computer-implemented method further includes generating a second system state data object associated with a second timepoint based at least in part on the first system state data object and the solar irradiance prediction data object. The second system state data object includes a second primary energy load state data value, a second energy storage subsystem state data value, and a solar photovoltaic energy source state data value.

In various embodiments, the computer-implemented method further includes determining a control command for each of the at least one primary energy load, the at least one secondary energy load, and the energy storage subsystem based at least in part on evaluating the second system state data object in an optimization model. The optimization model includes a cost function and one or more constraints. The one or more constraints are based at least in part on at least one objective relating to the at least one primary energy load, at least one objective relating to the at least one secondary energy load, and at least one objective relating to the energy storage subsystem. The control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage system.

In various embodiments, the computer-implemented method further includes causing energy to be supplied at the second timepoint to at least one of (i) the at least one primary energy load from the energy storage subsystem, (ii) the at least one secondary energy load from the energy storage subsystem, or (ii) the energy storage subsystem from the at least one solar photovoltaic energy source based at least in part on each of the determined control commands.

In accordance with another aspect of the present disclosure, an apparatus is provided. The apparatus may include at least one processor and at least one memory including computer program code. In one embodiment, the at least one memory and the computer program code may be configured to, with the at least one processor, cause the apparatus to receive a first system state data object (i) associated with a first timepoint, and (ii) including a first primary energy load state data value and a first energy storage subsystem state data value. The first system state data object is configured to describe an energy system including at least one primary energy load, at least one secondary energy load, and an energy storage subsystem configured to receive energy from at least one solar photovoltaic energy source and to provide energy to the at least one primary energy load and/or the at least one secondary energy load.

In various embodiments, the at least one memory and the computer program code may be further configured to, with the at least one processor, cause the apparatus to receive a solar irradiance prediction data object associated with a second timepoint subsequent to the first timepoint. In various embodiments, the at least one memory and the computer program code may be further configured to, with the at least one processor, cause the apparatus to generate a second system state data object associated with a second timepoint based at least in part on the first system state data object and the solar irradiance prediction data object. The second system state data object includes a second primary energy load state data value, a second energy storage subsystem state data value, and a solar photovoltaic energy source state data value.

In various embodiments, the at least one memory and the computer program code may be further configured to, with the at least one processor, cause the apparatus to determine a control command for each of the at least one primary energy load, the at least one secondary energy load, and the energy storage subsystem based at least in part on evaluating the second system state data object. The optimization model includes a cost function and one or more constraints. The one or more constraints are based at least in part on at least one objective relating to the at least one primary energy load, at least one objective relating to the at least one secondary energy load, and at least one objective relating to the energy storage subsystem. The control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage subsystem.

In various embodiments, the at least one memory and the computer program code may be further configured to, with the at least one processor, cause the apparatus to cause energy to be supplied at the second timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

In accordance with yet another aspect of the present disclosure, a computer program product is provided. The computer program product may include at least one computer-readable storage medium having computer-readable program code portions stored therein. In one embodiment, the computer-readable program code portions include executable portions configured to cause a processor to at least to receive a first system state data object (i) associated with a first timepoint, and (ii) including a first primary energy load state data value and a first energy storage subsystem state data value. The first system state data object is configured to describe an energy system including at least one primary energy load, at least one secondary energy load, and an energy storage subsystem configured to receive energy from at least one solar photovoltaic energy source and to provide energy to the at least one primary energy load and/or the at least one secondary energy load.

In various embodiments, the computer-readable program code portions include executable portions configured to cause a processor to receive a solar irradiance prediction data object associated with a second timepoint subsequent to the first timepoint. In various embodiments, the computer-readable program code portions include executable portions configured to cause a processor to generate a second system state data object associated with a second timepoint based at least in part on the first system state data object and the solar irradiance prediction data object. The second system state data object includes a second primary energy load state data value, a second energy storage subsystem state data value, and a solar photovoltaic energy source state data value.

In various embodiments, the computer-readable program code portions include executable portions configured to cause a processor to determine a control command for each of the at least one primary energy load, the at least one secondary energy load, and the energy storage subsystem based at least in part on evaluating the second system state data object. The optimization model includes a cost function and one or more constraints. The one or more constraints are based at least in part on at least one objective relating to the at least one primary energy load, at least one objective relating to the at least one secondary energy load, and at least one objective relating to the energy storage subsystem. The control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage subsystem.

In various embodiments, the computer-readable program code portions include executable portions configured to cause a processor to cause energy to be supplied at the second timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1A-B are diagrams of example system architectures that can be used in conjunction with various embodiments of the present disclosure;

FIG. 2 is a schematic of a computing entity in accordance with various embodiments of the present disclosure;

FIG. 3A-B are example block diagrams of a computing entity in accordance with various embodiments of the present disclosure; and

FIG. 4 is a process flow for managing and controlling an energy system based at least in part on optimizing energy generation and load use, in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. DEFINITIONS AND EXEMPLARY SCENARIO DEMONSTRATING VARIOUS EMBODIMENTS

The term “system state data object,” such as in “first system state data object” and “second system state data object,” may refer to a data entity configured to describe various aspects of various components of an energy system. In example embodiments, an energy system may comprise a primary energy load, a secondary energy load, and an energy storage subsystem configured to receive energy from an energy source and provide energy to the primary energy load and the secondary energy load. Accordingly, a system state data object for such example embodiments may comprise one or more state data values describing the primary energy load, one or more state data values describing the secondary energy load, and one or more data values describing the energy storage subsystem. It will be understood, however, that other example energy system may comprise additional, other, or fewer components, and a system state data object may comprise state data values describing any such components in an energy system. A system state data object may be an array, vector, matrix, data structure, embeddings, dataset, and/or the like comprising one or more state data values and configured to describe various aspects of various components of an energy system. A system state data object is configured to describe an energy system at a specific moment in time, and as such, a system state data object may be associated with a timepoint. For example, a first system state data object may describe an energy system at a first timepoint, and a second system state data object may describe the same energy system at a second timepoint.

The term “state data value” may refer to a data entity configured to describe an aspect of a component of an energy system. As aforementioned, in example embodiments, an energy system may comprise a primary energy load, a secondary energy load, and an energy storage subsystem configured to receive energy from an energy source and provide energy to the primary energy load and the secondary energy load. Accordingly, a state data value may be configured to describe an aspect of one of such energy system components (e.g., primary energy load, secondary energy load, energy storage subsystem). A state data value may be associated with a timepoint, or a state data value may be stored in a system state data object associated with a timepoint. As an example, an energy storage subsystem state data value may describe an energy amount stored in the energy storage subsystem at the associated timepoint. As another example, an energy storage subsystem state data value may describe a charging (or discharging) state of the energy storage subsystem at the associated timepoint. As yet another example, an energy source state data value may describe an energy amount produced by the energy source and/or an energy amount available to store in the energy storage subsystem via charging at the associated timepoint. As a further example, a primary energy load may be configured to control an internal temperature, and a primary energy load state data value may describe the internal temperature of the primary energy load at the associated timepoint. As yet a further example, a secondary energy load state data value may describe the operational state (e.g., on or off) of the secondary energy load. In various embodiments, a state data value may be a data object, n-order tensor, data structure, embeddings, dataset, and/or the like.

The term “optimization model” may refer to a data entity configured to determine one or more control commands for the energy system, or specifically for various components of the energy system (e.g., primary energy load, secondary energy load, energy storage subsystem). An optimization model may be configured to receive a system state data object and determine the one or more control commands based at least in part on minimizing a cost function for various state data values of the received system state data object. As such, a system state data object is evaluated in an optimization model. In various embodiments, an optimization model is a constrained optimization model; that is, the cost function is minimized with respect to various constraints for various state data values. For example, an optimization model may minimize a cost function by minimizing the amount of time spent charging an energy storage subsystem and by extension the amount of energy stored in the energy storage subsystem, with respect to a constraint indicating a minimum amount of energy to be stored in the energy storage subsystem. In various embodiments, an optimization model evaluates a system state data object and minimizes a cost function using a mixed integer linear program (MILP) and produces control commands that are integer values. In various embodiments, an optimization model may be a data structure, embeddings, data system, dataset, and/or the like, configured to receive and evaluate a system state data object and output control commands for the energy system to minimize a cost function.

The term “control command” may refer to a data entity configured to describe an instruction or a command for a component in the energy system. Specifically, a control command may describe an instruction for a component to operate in a specific operating state, such as an “on” state or an “off” state. In various embodiments, a control command may be an integer, and is determined based at least in part on a mixed integer linear program (MILP) of an optimization model. For example, a control command of “1” may indicate an instruction for a component to operate in an “on” state, while a control command of “0” may indicate an instruction for a component to operate in an “off” state. In various embodiments, a control command may be a n-order tensor, data structure, embeddings, dataset, and/or the like.

An example is now described that is used throughout the disclosure to demonstrate various embodiments of the present disclosure. This example is provided to assist the reader in understanding various embodiments and should not be construed to limit the scope of the present disclosure. As previously discussed, various embodiments may be applied to energy systems comprising at least one primary energy load, at least one secondary energy load, and an energy storage subsystem configured to receive energy from an energy source and provide energy to the at least one primary energy load and the at least one secondary energy load. In the current described example, the energy system is a home consisting of four bedrooms, a living room, and a kitchen and experiencing a power outage during a post-hurricane period. The minimum energy load that will provide habitable conditions includes a light emitting diode (LED) light for each room, a fan for each bedroom, and one refrigerator in the kitchen.

These three critical loads (e.g., refrigerator, lights, fans) are configured to be powered by and receive energy from a limited power supply that includes at least one solar photovoltaic energy source (e.g., solar photovoltaic panels) and an energy storage subsystem (e.g., a battery) during the outage. Among these critical loads, refrigeration for food and medicine is deemed to be the most important need, followed by lights and fans as secondary needs. The fans serve as temporary replacements for air conditioners to provide thermal comfort, and are much less energy intensive than air conditioners. Accordingly, the at least one primary energy load of the energy system of the home comprises the refrigerator, and the at least one secondary energy load of the energy system of the home comprises the lights and the fans. Although there are many more electrical loads in a typical home, others are not considered critical for health and well-being after a disaster. For this example, an objective is to keep the refrigerator temperature within a band or a temperature range, while another objective is to maximize the operational time (e.g., time spent in “on” state) of the at least one secondary energy load.

As noted, other examples may be used in demonstrating various embodiments of the present disclosure. For instance, the home may be experiencing a power outage due to other conditions, such as a snowstorm. Here, the home may be powered by a limited power supply that is a gas-powered generator, and the at least one primary energy load may, additionally or alternatively to a refrigerator, include a furnace heating the home. Yet another example may involve powering a remote location such as a camping ground using a portable solar power generator in which the at least one primary energy load comprises lights and/or a cooking stove in the evenings. Those of ordinary skill in the art can envision other examples in light of this disclosure.

### II. COMPUTER PROGRAM PRODUCTS, SYSTEMS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

a. Exemplary System Architecture

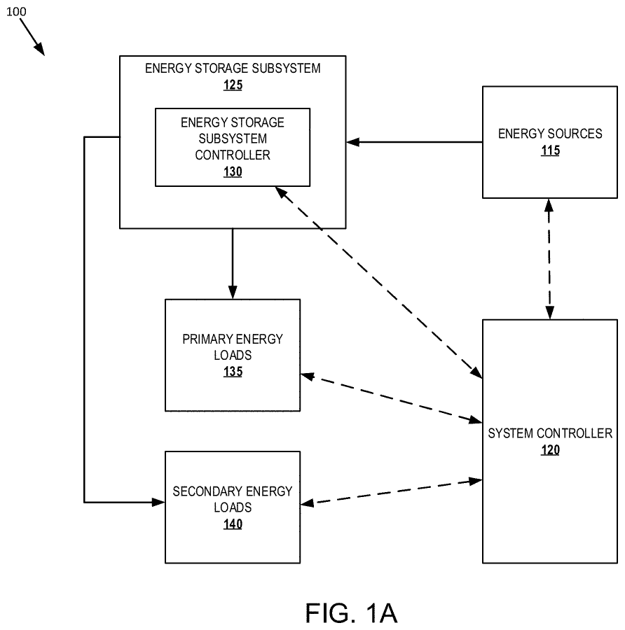

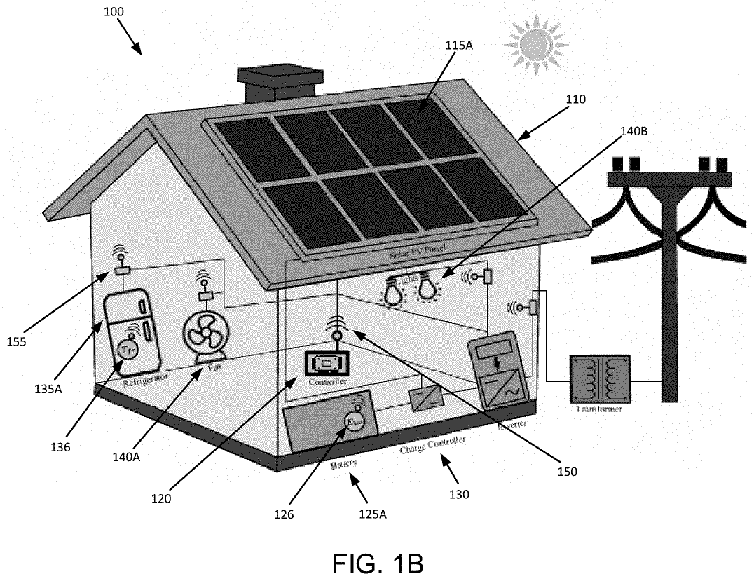

FIG. 1A provides an illustration of an example system architecture 100 in accordance with various embodiments of the present disclosure. The system architecture 100 comprises an energy system comprising an energy storage subsystem 125, primary energy loads 135, and secondary energy loads 140. As illustrated in the example embodiment, the energy storage subsystem 125 is configured to receive energy from energy sources 115 and provide energy to primary energy loads 135 and secondary energy loads 140. The system architecture 100 further comprises a system controller 120 configured to at least communicate with an energy storage subsystem controller 130 of the energy storage subsystem 125, the primary energy loads 135, the secondary energy loads 140, and/or the energy sources 115. As will be appreciated, the transfer of energy may occur along solid lines illustrated in FIG. 1A, while communication (e.g., data communication) may occur along dashed lines also illustrated in FIG. 1A.

In various embodiments, the system controller 120 is configured to receive a first system state data object associated with a first timepoint and comprising state data values, each state data value corresponding to one of the energy storage subsystem 125, the primary energy loads 135, the secondary energy loads 140, or the energy sources 115. In various embodiments, the system controller 120 is configured to cause energy to be supplied or provided to the primary energy loads 135, the secondary energy loads 140, and/or the energy storage subsystem 125 via control commands. Specifically, control commands transmitted by the system controller may cause energy to be supplied (i) to the primary energy loads 135 from the energy storage subsystem 125, (ii) to the secondary energy loads 140 from the energy storage subsystem 125, (iii) to the energy storage subsystem 125 from the energy sources 115 at a first charging rate, and/or (iv) to the energy storage subsystem 125 from the energy sources 115 at a second charging rate. In various embodiments, the system controller 120 is configured to communicate with other components (e.g., primary energy loads 135, secondary energy loads 140, energy storage subsystem 125, energy sources 115) using a network, wherein the network may be wired and/or wireless.

Referring now to FIG. 1B, a system architecture 100 is provided in accordance with the aforementioned example of a home. FIG. 1B illustrates a schematic of a home 110 with a limited power supply that includes solar photovoltaic (PV) panels 115A (i.e., an energy source 115), a battery 125A (i.e., an energy storage subsystem 125), and a charge controller 130A (i.e., an energy storage subsystem controller 130). For example, the PV panels 115A may be made up of three panels (e.g., Canadian Solar CS6K-285 polycrystalline panels) connected in parallel and the battery 125A may be made up of two battery units (e.g., Trojan SPRE 12225 (lead acid type) solar battery units) connected in series with the system DC voltage (V6) being 24V. Here, the home 110 is based at least in part on the example provided above and therefore, includes a refrigerator 135A (i.e., a primary energy load 135), fans 140A (i.e., a secondary energy load 140), and lights 140B (i.e., a secondary energy load 140).

Furthermore, the system architecture 100 includes a system controller 120 configured during a power outage to control the following: (i) on/off state of the refrigerator 135A, (ii) on/off state of the secondary energy loads 140 (aggregate of fans 140A and lights 140B), (iii) charging/discharging state of the battery 125A, and (iv) when charging the battery 125A, the charging mode or rate of the battery 125A. In various embodiments, the battery 125A has two charging rates: normal and fast. Energy may be stored in the battery 125A at a fast charging rate to prepare for a forecasted low solar irradiance event causing a lower amount of energy to be available at the PV panels 115A. Thus, flexibility in energy supply comes from the fact that the charging rate of the battery 125A is discretely variable between normal and fast charging rates. However, fast charging is generally less desirable since it typically degrades battery life quicker than normal charging. Therefore, an objective for managing and controlling the energy system may be to minimize the amount of time charging the battery 125A at the fast charging rate. In various embodiments, the charging rate of the battery 125A is continuously variable between 0 (e.g., not charging) and a maximum charging rate, which may be determined based at least in part on the properties of the battery 125A and degradation considerations.

The system controller 120 is further configured to communicate with various components (e.g., refrigerator 135A, fans 140A, lights 140B, battery 125A) over one or more networks. The networks may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. For instance, in particular embodiments, the system controller 120 may communicate with components over a wireless network using transmitter/receiver devices 150, 155. Further, the networks may have any suitable communication range associated therewith and may include, for example, global networks (e.g., the Internet), MANs, WANs, LANs, or PANs.

As noted, in the illustrated embodiment, an objective is to maintain an internal temperature of the refrigerator 135A within prescribed limits. Because this objective is related to the primary energy load 135, this objective may be considered the primary objective, and may be accordingly weighted, prioritized, and/or the like. In various embodiments, the refrigerator 135A comprises a temperature sensor 136 configured to at least measure the internal temperature of the refrigerator 135A and provide (e.g., transmit) the measured internal temperature to the system controller 120. Another objective may be to service (e.g., supply energy to) the secondary energy loads 140 during times that are pre-decided by occupants of the home 110. For example, the occupants may desire to have lights on from 18:00 hours to 00:00 hours and the fans running from 21:00 hours to 09:00 hours. As detailed further herein, various embodiments of the present disclosure attempt to achieve these objectives by the system controller 120 using at least: (i) forecasted or predicted solar irradiance, (ii) estimated home internal temperature, (iii) measured internal temperature of the refrigerator 135A, and (iv) measured energy level or amount of the battery 125A. For example, the system controller 120 may receive a first system state data object comprising a first primary energy load state data value describing the internal temperature of the refrigerator 135A and a first energy storage subsystem state data value describing the energy level or amount of the battery 125A. In various embodiment, the battery 125A comprises a battery sensor 126 configured to measure the energy level or amount of the battery 125A and provide (e.g., transmit) the measured energy level or amount to the system controller 120. Those skilled in art will recognize FIG. 1B represents but one possible configuration of a system architecture 100, and that variations are possible with respect to the protocols, facilities, components, technologies, and equipment used.

b. Exemplary Computing Entity

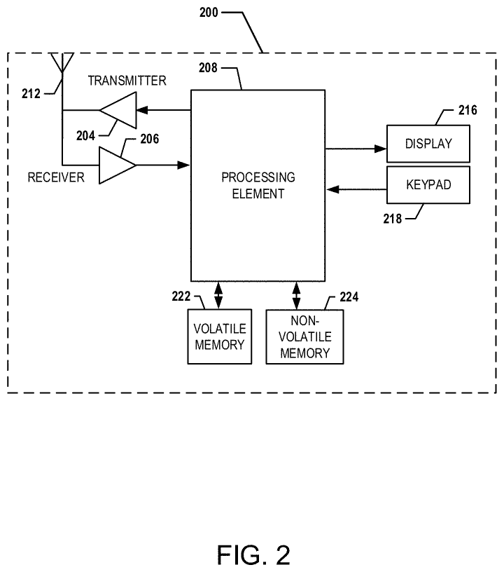

FIG. 2 provides an illustrative schematic representative of a computing entity 200 that can be used in conjunction with embodiments of the present disclosure. For instance, the computing entity 200 may be the system controller 120 found within the system architecture 100 previously described in FIG. 1. In general, the terms device, system, computing entity, entity, and/or similar words used herein interchangeably can refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. As shown in FIG. 2, the computing entity 200 can include an antenna 212, a transmitter 204 (e.g., radio), a receiver 206 (e.g., radio), and one or more processing elements 208 that provides signals to and receives signals from the transmitter 204 and receiver 206, correspondingly.

The signals provided to and received from the transmitter 204 and the receiver 206, correspondingly, can include signaling information/data in accordance with air interface standards of applicable wireless systems. In this regard, the computing entity 200 can be capable of operating with one or more air interface standards, communication protocols, modulation types, and access types. More particularly, the computing entity 200 can operate in accordance with any of a number of wireless communication standards and protocols, such as general packet radio service (GPRS), Universal Mobile Telecommunications System (UMTS), Code Division Multiple Access 2000 (CDMA2000), CDMA20001× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 200 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

With that said, the computing entity 200 may be configured in particular embodiments to operate in accordance with multiple wired communication standards and protocols via a network interface instead of or in addition to wireless systems. Here, any one or a combination of different types of suitable communications networks can be used such as, for example, cable networks, public networks, private networks, or any other suitable private and/or public networks. Further, the networks may have any suitable communication range associated therewith and may include, for example, global networks, MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, or any combination thereof, as well as a variety of network devices and computing platforms provided by network providers or other entities. Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol

In various embodiments, the computing entity 200 includes or is in communication with one or more processing elements 208 (also referred to as processors, processing circuitry, and/or similar terms used herein interchangeably) that communicate with other elements within the computing entity 200 via a bus, for example, or network connection. As will be understood, the processing element 208 may be embodied in several different ways. For example, the processing element 208 may be embodied as one or more complex programmable logic devices (CPLDs), microprocessors, multi-core processors, coprocessing entities, application-specific instruction-set processors (ASIPs), and/or controllers. Further, the processing element 208 may be embodied as one or more other processing devices or circuitry. The term circuitry may refer to an entirely hardware embodiment or a combination of hardware and computer program products. Thus, the processing element 208 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 208 may be configured for a particular use or configured to execute instructions stored in volatile or non-volatile media or otherwise accessible to the processing element 208. As such, whether configured by hardware, computer program products, or a combination thereof, the processing element 208 may be capable of performing steps or operations according to embodiments of the present disclosure when configured accordingly.

In various embodiments, the computing entity 200 may include or be in communication with non-volatile media (also referred to as non-volatile storage, memory, memory storage, memory circuitry and/or similar terms used herein interchangeably). For instance, the non-volatile storage or memory may include one or more non-volatile storage or memory media 224 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media 224 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium. In particular embodiments, the memory media 224 may also be embodied as a data storage device or devices, as a separate database server or servers, or as a combination of data storage devices and separate database servers.

In various embodiments, the computing entity 200 may further include or be in communication with volatile media (also referred to as volatile storage, memory, memory storage, memory circuitry and/or similar terms used herein interchangeably). For instance, the volatile storage or memory may also include one or more volatile storage or memory media 222 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media 222 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 208. Thus, the databases, database instances, database management system entities, data, images, applications, programs, program modules, scripts, source code, object code, byte code, compiled code, interpreted code, machine code, executable instructions, and/or the like may be used to control certain aspects of the operation of the computing entity 200 with the assistance of the processing element 208 and operating system. The computing entity 200 may be configured to download changes, add-ons, and updates, for instance, to its firmware, software (e.g., including executable instructions, applications, program modules), and operating system.

The computing entity 200 can also comprise a user interface (that can include a display 216 coupled to the processing element 208) and/or a user input interface (coupled to the processing element 208). For example, the user interface can be a user application, browser, user interface, graphical user interface, dashboard, and/or similar words used herein interchangeably executing on and/or accessible via the computing entity 200 to interact with and/or cause display of information/data. The user input interface can comprise any of a number of devices or interfaces allowing the computing entity 200 to receive data, such as a keypad 218 (hard or soft), a touch display, voice/speech or motion interfaces, or other input device. In embodiments including a keypad 218, the keypad 218 can include (or cause display of) the conventional numeric (0-9) and related keys (#, *), and other keys used for operating the computing entity 200 and can include a full set of alphabetic keys or set of keys that can be activated to provide a full set of alphanumeric keys. In addition to providing input, the user input interface can be used, for example, to activate or deactivate certain functions.

As will be appreciated, one or more of the computing entity's components may be located remotely from other computing entity components, such as in a distributed system. Furthermore, one or more of the components may be aggregated and additional components performing functions described herein may be included in the computing entity 200. Thus, the computing entity 200 can be adapted to accommodate a variety of needs and circumstances.

### II. EXEMPLARY SYSTEM OPERATION

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. Greater or fewer operations may be performed than shown in the figures and described herein. These operations may also be performed in a different order than those described herein.

a. Closed Loop Operation of Various Embodiments

Various embodiments of the present disclosure are directed to intelligent control systems and methods for providing resiliency of a limited power supply in an energy system by using intelligent and automated decision making to facilitate the trade-off of conflicting requirements. Specifically, in various embodiments, this intelligent decision making involves the use of forecasting of energy generation such as solar generation along with energy load demand to operate equipment (e.g., battery and energy consuming components) to fulfill various objectives, such as servicing critical loads to the maximum duration possible.

Here, a model predictive control (MPC) architecture is used that makes use of available measurements and forecasts to make optimal decisions in real time. In particular embodiments, the optimization problem is formulated as a mixed integer linear program (MILP). Accordingly, the integer valued variables may be used in particular embodiments to control the on/off status of one or more energy loads (e.g., primary energy loads 135, secondary energy loads 140). For instance, in the example, the integer valued variables may be used to control the on/off status of the refrigerator 135A, and the aggregate of the fans 140A and lights 140B. In addition, a dynamic model of an energy load (e.g., the refrigerator 135A) may be used to determine its current status (e.g., on/off status) to facilitate meeting a desired goal for the load such as, for example, facilitating the internal temperature of the refrigerator within an allowable band or temperature range.

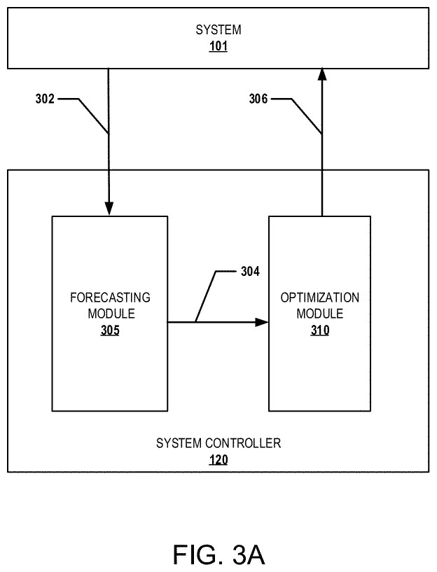

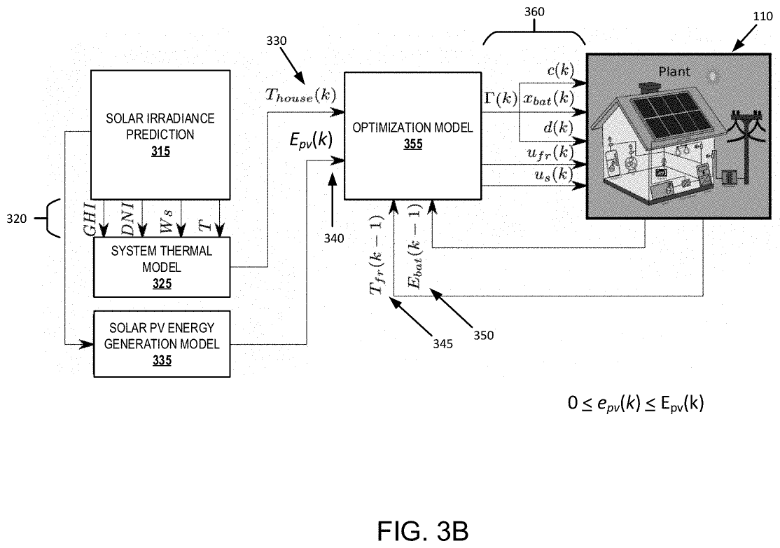

FIG. 3A provides a block diagram of closed loop operations in accordance with various embodiments of the present disclosure. As shown in FIG. 3A, the system controller 120 is configured to communicate with components of an energy system 101. For example, the system controller 120 is configured to communicate with an energy storage subsystem 125, primary energy loads 135, secondary energy loads 140, and energy sources 115.

At 302, the system controller 120 may receive a first system state data object from the system. In various embodiments, the system controller 120 receives state data values from each component of the energy system 101 and generates a first system state data object. For example, the system controller 120 receives a first primary energy load state data value describing an internal temperature of the refrigerator 135A and a first energy storage subsystem state data value describing the energy level or amount in the battery 125A, and a first system state data object comprising the first primary energy load state data value and the first energy storage subsystem state data value is generated. The first system state data object is associated with a first timepoint, and specifically describes the energy system 101 at the first timepoint.

The first system state data object is received by a forecasting module 305 of the system controller 120. In various embodiments, the forecasting module 305 is configured to generate a second system state data object. The second system state data object is associated with a second timepoint and describes the energy system 101 at the second timepoint. In various embodiments, the second system state data object is generated before the second timepoint and is a predictive description of the energy system 101 at the second timepoint.

The forecasting module 305 may be configured to generate the second system state data object based at least in part on a solar irradiance prediction data object and various models describing the dynamics of the components of the energy system 101. For example, the system controller 120 receives a solar irradiance prediction data object and stores various models describing the dynamics of the components of the energy system 101. In various embodiments, the solar irradiance prediction data object is, comprises, and/or is based at least in part on a weather forecast for an area within which the home 110 is located. It will be understood that the solar irradiance prediction data object may be directly relevant and provide information aiding in determining the performance of the PV panels 115A, due to the PV panels 115A producing energy from solar irradiance. It may be further understood that in other embodiments where another energy source may be used, the system controller 120 may receive other predictive data objects that may be used to determine an energy amount that may be available at an energy source 115.

The system controller 120 may store various models that describe the dynamics of the components of the energy system 101. In various embodiments, the forecasting module specifically stores the various models. Several such models are now introduced that are used in various embodiments of the present disclosure. These particular models are discussed with respect to the example described herein involving powering the three critical loads of the refrigerator 135A, fans 140A, and lights 140B by PV panels 115A and a battery 125A during an outage. However, those of ordinary skill in the art will understand the models can be adjusted to accommodate other critical loads and/or environments in light of this disclosure.

In the following models, time is discrete, with k 01, 2, . . . denoting various timepoints, and Δk denoting the interval (hours or minutes) between k and k+1. Thus, in the following models, time may be understood as a sequence of timepoints. In various embodiments, the timepoints may be evenly spaces, such that Δk is constant. In general, terms of the following models labelled as E(k) denote the energy consumed/generated in units of watt-hours (Wh) during the time interval between timepoints k and k+1. Such terms may be further labelled with a subscript specifying the source or consumer of the energy (e.g., refrigerator 135A, fans 140A, lights 140B, battery 125A, PV panels 115A). The dependence on k may be omitted in some terms in various models; for example, x may be used instead of x(k).

### 1. Solar Photovoltaic Generation Model

The system controller 120 and/or the forecasting module 305 may store a model describing the dynamics of energy generation at the energy source 115. For example, the model may be a solar photovoltaic generation model for the PV panels 115A. The system controller 120 and/or the forecasting module 305 may use the solar photovoltaic generation model to determine and generate a solar photovoltaic energy source state data value of a second system state data object associated with a timepoint k. Specifically, the solar photovoltaic energy source data value may be based at least in part on a maximum PV energy potential value Eₚᵥ(k) outputted by the model. The maximum PV energy potential value Eₚᵥ(k) describes the maximum energy the PV panels 115A can produce at timepoint k, and may be dependent on the temperature of the PV panels 115A and solar irradiance. In various embodiments, the temperature of the PV panels 115A is the same and/or is modelled as the temperature of the home 110. In various embodiments, timepoint k is in the future, and therefore, the maximum PV energy potential value Eₚᵥ(k) is predictive in nature and depends on the predicted temperature of the PV panels 115A and predicted solar irradiance at timepoint k. The solar photovoltaic generation model comprises the following equation to determine the output energy potential value:

$${E}_{pv} ( k ) = {N}_{pv} {P}_{pv}^{rated} ( \frac{G ( k )}{{G}_{std}} ) \times ( 1 + \frac{γ}{100} ( {T}_{m} ( k ) - {T}_{std} ) ) Δ \text{?}$$

$$\text{?} \text{indicates text missing or illegible when filed}$$

where Nₚᵥ describes the number of PV panels 115A, p^{rated} describes the rated power output of the PV panels 115A in units of watts [W], γ describes the temperature coefficient of power of the PV panels 115A in units of percentage per degree Celsius [%/° C.], Tₘ(k) describes the temperature of the PV panels 115A at timepoint kin units of Celsius [° C.], T_{std} describes the ambient air temperature at standard test condition in units of degrees Celsius [° C.], G(k) describes the solar irradiance at timepoint k in units of watts per meter squared [W/m²], and G_{std} describes solar irradiance at standard test condition in units of watts per meter squared [W/m²].

In various embodiments, the temperature of the PV panels 115A at timepoint k (e.g., a future timepoint) may be determined or predicted based at least in part on the ambient air temperature (Tₐₘ in ° C.) and wind speed (Wₛ in m/s) at timepoint k by the following equation:

$${T}_{m} ( k ) = {T}_{am} ( k ) + \frac{G ( k )}{{U}_{0} + {U}_{1} + {W}_{s} ( k )} ,$$

where U₀ describes the constant heat transfer component in units of watts per meters squared-Kelvin [W/m²K], and U₁ describes the convective heat transfer component in units of watts per meters squared-Kelvin [W/m²K]. In various embodiments, the ambient air temperature Tₐₘ(k) and wind speed Wₛ(k) at timepoint k may be values in the solar irradiance prediction data object based at least in part on a weather forecast (e.g., timepoint k is in the future, and ambient air temperature and windspeed are predicted in a weather forecast). Likewise, the solar irradiance G(k) at timepoint k may be a value in the solar irradiance prediction data object.

As such, the system controller 120 and/or the forecasting module 305 may be configured to determine and generate a solar photovoltaic energy source state data value of a second system state data object associated with a timepoint k based at least in part on the solar irradiance prediction data object. FIG. 3B illustrates a block diagram also illustrating closed loop operations in accordance with various embodiments of the present disclosure. For example, FIG. 3B specifically illustrates a solar PV energy generation model 335 receiving a solar irradiance prediction data object 315, which may comprise data values 320 for timepoint k such as solar irradiance, ambient air temperature, and wind speed. FIG. 3B further illustrates the solar PV energy generation model 335 determining and generating a solar photovoltaic energy source state data value 340, which may be based at least in part on a maximum PV energy potential value Eₚᵥ(k).

### 2. Battery Energy Storage Model

Returning to FIG. 3A, the system controller 120 and/or the forecasting module 305 may store a model describing the dynamics of energy storage at the energy storage subsystem 125. For example, the model may be a battery energy storage model for the battery 125A. In various embodiments, the battery 125A storage system may be modelled as a bucket of energy. In various embodiments, the system controller 120 and/or the forecasting module 305 may use the battery energy storage model to determine and generate an energy storage subsystem state data value of a second system state data object associated with a timepoint k. Specifically, the generated energy storage subsystem state data value may be a second energy storage subsystem state data value and may be based at least in part on a first energy storage subsystem state data value associated with a timepoint prior to the timepoint k (e.g., timepoint k−1). For example, the generated energy storage subsystem state data value may be based at least in part on a battery energy level value E_{bat}(k) determined by the following equation:

E_{bat}(k)=E_{bat}(k−1)+η_{bat}^{c}E_{bat}^{c}(k−1)−E_{bat}^{dc}(k−1)/η_{bat}^{dc},

where E_{bat}(k−1) describes the battery energy level at a previous timepoint k−1 in units of watt-hours [Wh], E_{bat}^{c}(k−1) is the energy absorbed by the battery 125A from energy sources 115 (e.g., PV panels 115A) during charging in units of watt-hours [Wh], and E_{bat}^{dc}(k−1) is the energy provided by the battery 125A to one or more energy loads (e.g., primary energy loads 135, secondary energy loads 140) during discharging in units of watt-hours [Wh]. η_{bat}^{c} and η_{bat}^{dc} are the charging efficiency and the discharging efficiency of the battery 125A, respectively. In various embodiments, the battery 125A has a minimum energy limit and a maximum energy limit, and as such, the battery energy level values E_{bat}(k) and E_{bat}(k−1) are bounded between the minimum energy limit and the maximum energy limit. In various embodiments, the battery 125A has a maximum energy absorption limit and a maximum energy supply limit during Δk; that is, the battery 125A has a maximum charging rate and a maximum discharging rate. As such, the absorbed energy E_{bat}^{c} is bounded by the maximum energy absorption limit, and the supplied energy E_{bat}^{dc} is bounded by the maximum energy supply limit.

As such, the system controller 120 and/or the forecasting module 305 may be configured to determine and generate a second energy storage subsystem state data value of a second system state data object associated with a timepoint k based at least in part on data of the battery from a previous timepoint k−1. For example, the data from a previous timepoint k−1 may be received as one or more first energy storage subsystem state data values in and/or with a first system state data object.

### 3. Refrigerator Thermal Dynamic Model

The system controller 120 and/or the forecasting module 305 may generally store a model relating to a primary objective for the primary energy loads 135 and configured to determine and generate a primary energy load state data value at each timepoint k. In the aforementioned example, the model may be a refrigerator thermal dynamic model relating to the primary objective of maintaining the internal temperature of the refrigerator within an allowable band or temperature range. In various embodiments, the refrigerator thermal dynamic model determines and generates a second primary energy load state data value associated with timepoint k based at least in part on a first primary energy load state data value associated with a previous timepoint k−1. A primary energy load state data value may be based at least in part on a refrigerator internal temperature value determined by the following equation:

T_{fr}(k)=AT_{fr}(k−1)+Bu_{fr}(k−1)Q_{fr}+DTₕₒᵤₛₑ(k−1),

where T_{fr}(k−1) describes the internal temperature of the refrigerator 135A at a previous timepoint k−1 in units of degrees Celsius [° C.], and u_{fr}(k−1) describes the operational state of the refrigerator 135A (e.g., on or off) at the previous timepoint k−1. In various embodiments, u_{fr} may be a previously determined control command for the refrigerator 135A at a previous timepoint k−1. In various embodiments, u_{fr} is an integer, due to control commands being integers. In the above equation, Q_{fr} describes the thermal power rejected by the refrigerator 135A to the ambient environment when in an “on” operational state (e.g., the compressor is on) in units of watts [W]. In various embodiments, the thermal power rejected by the refrigerator 135A may be dependent on a coefficient of performance (COP) of the refrigerator 135A, and as such, Q_{fr} may be equal to COP*P_{fr}^{rated} where P_{fr}^{rated} is the rated power consumption of the refrigerator 135A.

In the above equation, Tₕₒᵤₛₑ(k−1) describes the home internal temperature at the previous timepoint k−1 in units of degrees Celsius [° C.]. In various embodiments, Tₕₒᵤₛₑ(k−1) may be a measured state data value received in and/or with the first system state data object. For example, the home 110 may comprise a temperature sensor configured to measure and provide (e.g., transmit) a home internal temperature value. As shown in FIG. 3B, Tₕₒᵤₛₑ(k−1) may be estimated using a system thermal model 325 based at least in part on data of the solar irradiance prediction data object 315, such as ambient temperature Tₐₘ and wind speed Wₛ. In various embodiments, a home internal temperature data value 330 may be determined and generated similar to determining the temperature of the PV panels 115A. A home internal temperature data value 330 for the timepoint k may also be determined or predicted.

In various embodiments, the above equation may be a time-discretized form of a continuous-time thermal dynamic equation. As such, A, B, and D are the discrete time equivalents of terms in a continuous-time thermal dynamic equation and are given by:

$$A = {e}^{{A}_{c} Δ k} , B = \frac{1}{{A}_{c}} ( {e}^{{A}_{c} Δ k} - 1 ) {B}_{c} , D = \frac{1}{{A}_{c}} ( {e}^{{A}_{c} Δ k} - 1 ) {D}_{c}$$

where A_{c}, B_{c}, and D_{c} are the continuous time constants of the model given as follows:

$${A}_{c} = \frac{- 1}{{C}_{fr} , {R}_{fr}} , {B}_{c} = \frac{- 1}{{C}_{fr}} , {D}_{c} = \frac{1}{{C}_{fr} {R}_{fr}} ,$$

where R_{fr} describes the thermal resistance of the refrigerator 135A in units of degrees Celsius per watt [° C./W], and C_{fr} describes the thermal capacitance of the refrigerator 135A in units of Joules per degree Celsius [J/° C.].

As such, the system controller 120 and/or the forecasting module 305 may be configured to determine and generate a second primary energy load state data value of a second system state data object associated with a timepoint k. The second primary energy load state data value may be based at least in part on various properties (e.g., thermal resistance, thermal capacitance, thermal power rejection) of the refrigerator 135A, a first primary energy load state data value associated with a previous timepoint (e.g., timepoint k−1), a previous control command for the refrigerator 135A associated with a previous timepoint (e.g., timepoint k−1), and a home internal temperature data value 330 at a previous timepoint (e.g., timepoint k−1). The home internal temperature data value 330 may have been measured (e.g., by a temperature sensor), in some embodiments, or may have been estimated and predicted with a system thermal model 325 based at least in part on data from a solar irradiance prediction data object 315.

### 4. Energy Load Consumption Models

The system controller 120 and/or the forecasting module 305 may store models describing the dynamics of energy consumption at the energy loads (e.g., primary energy loads 135, secondary energy loads 140). In various embodiments, the energy consumed by each energy load (e.g., refrigerator 135A, fans 140A, lights 140B) is described by a model comprising the integral of the rated power the respective energy load multiplied by the number of individual energy load units. For example, a model describing energy consumption by the refrigerator 135A comprises the equation E_{fr}(k)=(P_{fr}^{rated}) Δk, which outputs a refrigerator energy consumption value E_{fr}(k) associated with a timepoint k in units of watt-hours [Wh], where P_{fr}^{rated} describes the rated power of the refrigerator 135A in units of watts [W].

For example, a model describing energy consumption by the fans 140A comprises the equation E_{f}(k)=(N_{f} P_{f}^{rated}) Δk, which outputs a fans energy consumption value E_{f}(k) associated with a timepoint k in units of watt-hours [Wh], where P_{f}^{rated} describes the rated power of the fans 140A and N_{f} describes the number of individual fans in the fans 140A are consuming energy. Similarly, a model describing energy consumption by the lights 140B comprises the equation Eₗ(k)=(Nₗ Pₗ^{rated}) Δk, which outputs a lights energy consumption value Eₗ(k) associated with a timepoint kin units of watt-hours [Wh], where Pₗ^{rated} describes the rated power of the lights 140B and Nₗ describes the number of individual lights in the lights 140B are consuming energy.

In various embodiments, the fans energy consumption value E_{f}(k) and the lights energy consumption value Eₗ(k) may be aggregated and summed to form a secondary energy load state data value describing the energy consumed by the secondary energy loads 140. For example, the secondary energy load state data value may be based at least in part on the equation Eₛ(k) Eₗ(k)+E_{f}(k), where Eₛ(k) describes the energy consumed by the secondary energy loads 140.

As such, the system controller 120 and/or the forecasting module 305 may be configured to determine and generate a primary energy load state data value describing the energy consumption of the refrigerator 135A and a secondary energy load state data value describing the energy consumption of the secondary energy loads 140 (e.g., fans 140A, lights 140B) for any timepoint based at least in part on inherent properties or characteristics (e.g., rated powers) for each energy load.

Returning to FIG. 3A now, the system controller 120 generates a second system state data object using various models as described above and other received data (e.g., first system state data object, solar irradiance prediction data object 315). In various embodiments, the forecasting module 305 generates the second system state data object. In various embodiments, at 304, the forecasting module 305 then provides the second system state data object to an optimization module 310 to determine control commands for each component of the energy system, such as the primary energy loads 135, the secondary energy loads 140, and the energy storage subsystem 125. Thus, the system controller 120 determines and/or generates control commands based at least in part on the second system state data object.

In various embodiments, the control commands are computed by the optimization module 310 for discrete timepoints k=1, 2, . . . N with Δk as the sampling period, where N is the total number of timepoints in a planning/prediction horizon. In various embodiments, the optimization module 310 comprises an optimization model configured to evaluate the second system state data object to determine the control commands for components of the energy system. In various embodiments, the optimization model is configured to determine the control commands based at least in part on minimizing a cost function.

First, the cost function involves decision variables, or a decision vector. In various embodiments, the decision vector includes a state vector x(k)=[E_{bat}(k), T_{fr}(k)]^{T}, a control command vector u(k)=[Γ(k), u_{fr}(k), uₛ(k)]^{T}, where Γ(k) is the fraction of the normal battery charging energy, and an internal variable vector v(k)=[eₚᵥ(k), ζ_{fr}(k)]^{T}, where eₚᵥ(k) is the energy produced by the PV panels 115A between timepoints k and k+1, and ζ_{fr}(k) is a slack variable for the internal temperature of the refrigerator 135A to ensure feasibility. Hence, the complete decision vector for the optimization problem is given as [X, U, V]^{T}, where X:=[x(k+1), . . . , x(k+N)]^{T}, U:=[u(k), . . . , u(k+N−1)]^{T} and V:=[v(k), . . . , v(k+N−1)]^{T}. The cost function may further involve an exogenous input vector including predicted values for N timepoints. For example, the exogenous input vector may be w(k)=[Eₚᵥ(k), Tₕₒᵤₛₑ(k), Eₛ(k)]^{T}, where Eₚᵥ(k) and Eₛ(k) are the available energy from the PV panels 115A computed using the solar photovoltaic generation model and the secondary energy loads 140 computed from the energy load consumption models respectively.

The cost function itself may be given as follows:

$${min}_{X , U , V} {\sum }_{k = j}^{j + N - 1} [ {λ}_{1} ( N - k ) {ζ}_{fr} ( k ) - {λ}_{2} {E}_{bat} ( k ) + {λ}_{3} Γ ( k ) - {λ}_{4} ( N - k ) {u}_{s} ( k ) ] ,$$

In various embodiments, the optimization module 310 evaluates the above cost function to determine and generate control commands for N timepoints to fulfill various objectives. As aforementioned, a primary objective may be to maintain an internal temperature of the refrigerator 135A within an allowable band or temperature range. Other objectives may include maximizing the energy amount or level in the battery 125A, minimizing the health degradation of the battery 125A (e.g., by minimizing fast charging of the battery 125A), and/or maximizing the operation (e.g., time spent supplying energy to) the secondary energy loads 140. The cost function may include terms that help in achieving these objectives. The first term, λ₁(N−k)ζ_{fr} (k), penalizes the refrigerator temperature slack variable, which enables the optimization module 310 to determine control commands to maintain the internal temperature of the refrigerator 135A within an allowable band. The time varying weighing factor N−k puts a higher penalty on the slack variable at earlier timepoints and less weight on later timepoints, which in turn translates to having a smaller slack during the initial timepoints of the planning horizon.

The second term, −λ₂E_{bat}(k), penalizes a low state of charge, which enables the optimization module 310 to determine control commands to extend the life-time of the system. The third term, λ₃Γ(k), puts a higher penalty on faster battery charging rates, enabling the optimization module 310 to determine control commands to minimize the health degradation of the battery 125A. Γ(k) models the fraction of the charging-discharging energy of the battery and is continuous and variable. Moreover, Γ(k) may depend on the amount of energy available from the PV panels 115A during charging, and the amount of energy to be supplied during discharging. Thus, this third term may cause the optimization module 310 to determine control commands for normal charging instead of fast charging more often, since fast charging reduces battery health.

The fourth term, −λ₄(N−k)uₛ(k), along with the inequality constraint uₛ<uₛ(k)<ūₛ(k) maximizes the operation of the secondary energy loads 140 when desired. The reason for the time varying weighing factor in this term is similar to that in the first term. That is, the time varying weighing factor N−k puts a higher penalty on the operation of the secondary energy loads 140 at earlier timepoints and less weight on later timepoints. In various embodiments, the parameters λ1, λ2, λ3, and λ4 are configurable and selected based at least in part on a desired response. As will be appreciated, these terms of the function may be determined or selected based at least in part on the various objectives for the energy system.

In particular, at least some objectives are achieved based at least in part on evaluating the above cost function subject to various constraints. These constraints may be constraints on the energy dynamics of the refrigerator 135A and/or the battery 125A, an energy balance equation, constraints on the energy level of the battery 125A, and/or the constraints on the charging and discharging rate of the battery 125A. Various embodiments may include the following constraints:

T_{fr}(k+1)=AT_{fr}(k)+Bu_{fr}(k)Q_{fr}+DTₕₒᵤₛₑ(k).

E_{bat}(k+1)=E_{bat}(k)+Γ(k)η_{bat}^{c,dc,con}Ē_{bat}^{c},

u_{fr}(k)E_{fr}+Γ(k)Ē_{bat}^{c}+uₛ(k)Eₛ(k)=eₚᵥ(k)

T_{fr}≤T_{fr}(k)≤T̅_{fr}+ζ_{fr}(k),

ζ_{fr}(k)≥0,

E_{bat}≤E_{bat}(k)≤Ē_{bat},

uₛ≤uₛ(k)≤ūₛ(k),

Γ≤Γ(k)≤Γ̅,

0≤eₚᵥ(k)≤Eₚᵥ(k).

The equality constraint for T_{fr}(k+1) constrains the internal temperature of the refrigerator 135A according to the thermal dynamics of the refrigerator 135A. The equality constraint for E_{bat}(k+1) constrains the energy level of the battery 125A according to the energy dynamics of the battery 125A, where Ē_{bat}^{c} describes the maximum battery charging energy (the maximum battery discharging energy is assumed to be equal to the maximum battery charging energy) at the normal charging rate, and η_{bat}^{c,dc,con} describes the charging-discharging efficiency of the battery 125A. This equality constraint for the battery 125A models the battery charging and discharging energies with a single continuous variable (Γ). The equality constraint u_{fr}(k)E_{fr}+Γ(k)Ē_{bat}^{c}+uₛ(k)Eₛ(k)=eₚᵥ(k) is the energy balance equation.

The inequality constraint T_{fr}≤T_{fr}(k)≤T̅_{if}+ζ_{fr}(k) constrains the internal temperature of the refrigerator 135A within the lower (T_{fr}) and upper (T̅_{fr}) temperature limits. In various embodiments, the lower and upper temperature limits may be configured (e.g., via user input). The inequality constraint ζ_{fr}(k)≥0 constrains the refrigerator temperature slack variable to positive values. The inequality constraint E_{bat}<E_{bat}(k)<Ē_{bat} constrains the energy level of the battery between the minimum (E_{bat}) and maximum (Ē_{bat}) battery energy limits. The inequality constraint uₛ<u(k)<ūₛ(k) forces the secondary energy load control command to be zero when the secondary energy loads 140 are not desired to be turned on by the occupants, where uₛ and ūₛ are the lower and upper bound on uₛ respectively, and are defined as follows:

$${\overline{u}}_{s} ( k ) = \{ \begin{matrix}1 , & if {E}_{s} ( k ) > 0 \\ 0 , & if {E}_{s} ( k ) = 0\end{matrix} \\ {\underline{u}}_{s} ( k ) = 0 , ∀ k = 1 , 2 , … , N .$$

The inequality constraint Γ<Γ(k)<Γ̅ constrains the fraction of battery charging energy between a minimum and maximum value. For example, in some embodiments, the minimum value Γ̅ is −1, and the maximum value Γ̅ is 2. In such embodiments, negative values for Γ describe discharging of the battery 125A. Meanwhile, positive Γ values under 1 describe charging of the battery 125A at the normal charging rate with a battery charging energy of Ē_{bat}^{c} as a maximum. Positive Γ values above 1 describe charging the battery 125A at the fast charging rate with twice the normal battery charging energy of 2×Ē_{bat}^{c} as the maximum, in such embodiments. The inequality constraint 0<eₚᵥ(k)<Eₚᵥ(k) bounds the energy produced by the PV panels 115A such that it cannot be negative and is always less than or equal to the maximum PV energy potential value Eₚᵥ(k) (i.e., the solar photovoltaic energy source state data value 340).

The control commands up and uₛ are modeled as binary integer variables, taking values in {1, 0} to turn the energy loads (e.g., primary energy loads 135, secondary energy loads 140) on and off respectively. Thus, in various embodiments, the cost function is a mixed integer linear program (MILP).

In various embodiments, the optimization module 310 considers the interactions between the PV panels 115A, the battery 125A, and the loads (e.g., the primary energy loads 135, the secondary energy loads 140) when determining the control commands for each component of the energy system 101. With respect to the example, such interactions may be represented using the following equations:

$${E}_{pv} ( k ) = {E}_{pv}^{u} ( k ) + {E}_{pv}^{un} ( k ) , \\ {E}_{hl} ( k ) = \frac{{u}_{fr} ( k ) {E}_{fr} ( k ) + {u}_{s} ( k ) {E}_{s} ( k )}{{η}_{inv}} , \\ {E}_{pv}^{u} ( k ) = {E}_{hl} ( k ) + {E}_{bat}^{c} ( k ) , \\ {E}_{bat}^{c} ( k ) = c ( k ) min \{ {E}_{pv} ( k ) - {E}_{hl} ( k ) , {\overline{E}}_{bat} - {E}_{bat} ( k ) , {x}_{bat} ( k ) {\overline{E}}_{bat}^{c} \} , \\ {E}_{bat}^{dc} ( k ) = d ( k ) min \{ {E}_{hl} ( k ) - {E}_{pv} ( k ) , {E}_{bat} ( k ) - {\underline{E}}_{bat} , {\overline{E}}_{bat}^{dc} \} .$$

Eₚᵥ(k) describes that the maximum PV energy that can potentially be produced by the PV panels 115A is equal to the PV energy used (described by Eₚᵥⁿ) and the PV energy unused (described by Eₚᵥ^{un}) between the timepoints k and k+1.

Eₕₗ(k) describes that the total energy used by the energy system 101 (i.e., the primary energy loads 135 and the secondary energy loads 140) is based at least in part on the energy used by the refrigerator 135A (described by E_{fr}) and the secondary energy loads 140 (described by Eₛ) between the timepoints k and k+1, where u_{fr} is the control command for the refrigerator 135A, uₛ is the control command for the secondary energy loads 140, and rn is the efficiency of an inverter of the energy system 101.

Eₚᵥ^{u} (k) describes that the PV energy used is substantially equal to the total energy used by the energy system 101 (described by Eₕₗ(k)) and the amount of energy charged by the battery 125A (described by E_{bat}^{c}) between the timepoints k and k+1.

E_{bat}^{c}(k) describes the amount of energy charged by the battery 125A being limited by the maximum battery energy limit (Ē_{bat}), where x_{bat} is either 1 or 2 (1—normal charging and 2—fast charging), Ē_{bat}^{c} is the maximum battery charging energy, and c is the control command for battery charging (c=1 for charging, c=0 for not charging).

E_{bat}^{dc}(k) describes the amount of energy discharged by the battery 125A being bounded by the minimum battery energy limit (E_{bat}), where Ē_{bat}^{dc} is the maximum battery discharging energy, and d is the control command for battery discharging (d=1 for discharging, d=0 for not discharging).

Thus, the optimization module 310 determines and generates control commands used in controlling the energy usage of the refrigerator 135A, fans 140A, and lights 140B, as well as the charging and discharging of the battery 125A. Specifically, the control commands may include control commands u_{fr} and uₛ for turning the energy supply for the refrigerator 135A and the secondary energy loads 140 on and off based at least in part on whether u_{fr} and uₛ are 1 and 0 respectfully. In addition, the continuous variable F is converted into appropriate discrete integer control commands: c (charging), d (discharging), and x_{bat} (fast or normal charging) in the following manner:

$$c ( k ) = \{ \begin{matrix}1 , & if Γ ( k ) > 0 \\ 0 , & if Γ ( k ) \leq 0\end{matrix} \\ d ( k ) = \{ \begin{matrix}1 , & if Γ ( k ) \leq 0 \\ 0 , & if Γ ( k ) > 0\end{matrix} \\ {x}_{bat} ( k ) = \{ \begin{matrix}1 , & if 0 > Γ ( k ) \leq 1 \\ 2 , & if 1 > Γ ( k ) \leq 2 \\ 0 , & otherwise .\end{matrix}$$

In various embodiments then, at 306, the system controller 120 and/or the optimization module 310 provides the control commands (e.g., u_{fr}, uₛ, c, d, x_{bat}) to the energy system 101 to control the energy usage of various components of the energy system 101. For example, the system controller 120 transmits the control command u_{fr} for the refrigerator 135A from a transmitter 150 such that a receiver 155 of the refrigerator 135A receives the control command u_{fr} and accordingly causes the refrigerator 135A to either operate in an “on” state if u_{fr} is “1” or an “off” state if u_{fr} if “0.” Likewise, the system controller 120 provides the control command uₛ to the secondary energy loads 140 (e.g., fans 140A, lights 140B) such that the secondary energy loads 140 operate in either an “on” or an “off” state (consuming energy accordingly) based at least in part on the control command uₛ. Similarly, the system controller 120 provides the control commands c, d, and x_{bat} to the energy storage subsystem controller 130 such that the energy storage subsystem 125 (e.g., the battery 125A) may charge at a normal charging rate, charge at a fast charging rate, or discharge.

Referring again to FIG. 3B, a closed loop operation is illustrated. The closed loop operation illustrated in FIG. 3B may be similar to, may be an embodiment of, and/or the like, of the operations illustrated and described in FIG. 3A. In the closed loop operation, information on the forecasted weather may be received that includes the forecasted irradiance such as, for example, the global horizonal irradiance (GHI) and the diffuse horizontal irradiance (DNI), in addition to the wind speed (Ws) and ambient temperature (T). For example, a solar irradiance prediction data object 315 is received, the solar irradiance prediction data object 315 comprising data values 320 for each of the GHI, DHI, wind speed, and ambient temperature. Accordingly, the forecasted irradiance, wind speed, and ambient temperature may be used by a system thermal model 325 to calculate an estimated home internal temperature value (Tₕₒᵤₛₑ(k)) 330. In various embodiments, the system thermal model 325 is configured to calculate an estimated temperature of the PV panels 115A and provide the estimated temperature of the PV panels 115A to a solar PV energy generation model 335. In other embodiments, the solar PV energy generation model 335 determines an estimated temperature of the PV panels 115A. The solar PV energy generation model 335 may further use data values 320 of the solar irradiance prediction data object 315 to calculate a solar photovoltaic energy source state data value 340 describing the maximum PV energy predicted to be available from the PV panels 115A at timepoint k.

The estimated home internal temperature data value 330 and the solar photovoltaic energy source state data value 340 are then used along with a first primary energy load state data value 345 describing the internal temperature (T_{fr}(k−1)) of the refrigerator 135A at a first timepoint k−1 and a first energy storage subsystem state data value 350 describing the energy level (E_{bat}(k−1)) of the battery 125A at a first timepoint k−a 1 as inputs to the optimization model 355 to determine the control commands 360 for the appropriate components in the home 110.

Thus, in various embodiments, the system controller 120 performs the closed loop control operations illustrated in FIGS. 3A and/or 3B and uses a first integer valued control command 360 (u_{fr}) to regulate whether energy (e.g., turn on or off) is supplied to the refrigerator 135A at a second timepoint k. In addition, the system controller 120 uses a second integer valued control command 360 (uₛ) to regulate whether energy is supplied to the fans 140A and lights 140B at the second timepoint k. These control commands 360 are determined to enable the system controller 120 to operate the refrigerator 135A, the fans 140A, and the lights 140B in a particular manner to achieve various objectives. For example, based at least in part on the control commands 360, the system controller 120 services (e.g., causes energy to be provided to) the refrigerator 135A such that the internal temperature of the refrigerator is within an allowable band, while also servicing the secondary energy loads 140 for as long as possible. Furthermore, the system controller 120 may be configured to provide control commands 360 (c, d, and x_{bat}) to the energy storage subsystem controller 130 of the battery 125A to regulate the charging and discharging of the battery 125A and when charging, the charging rate for the battery 125A (e.g., fast or normal).

In various embodiments, the closed loop operations illustrated in FIGS. 3A and 3B are performed as successive iterations, resulting in the control commands 360 being associated with a timepoint, re-calculated at successive timepoints, and applied by the system controller 120 at the associated timepoint accordingly. Thus, various embodiments are enabled to make optimal decisions with respect to providing energy to the primary energy loads 135 and the secondary energy loads 140 (e.g., the fans 140A and lights 140B), as well as the charging and discharging of the battery 125A, in real time.

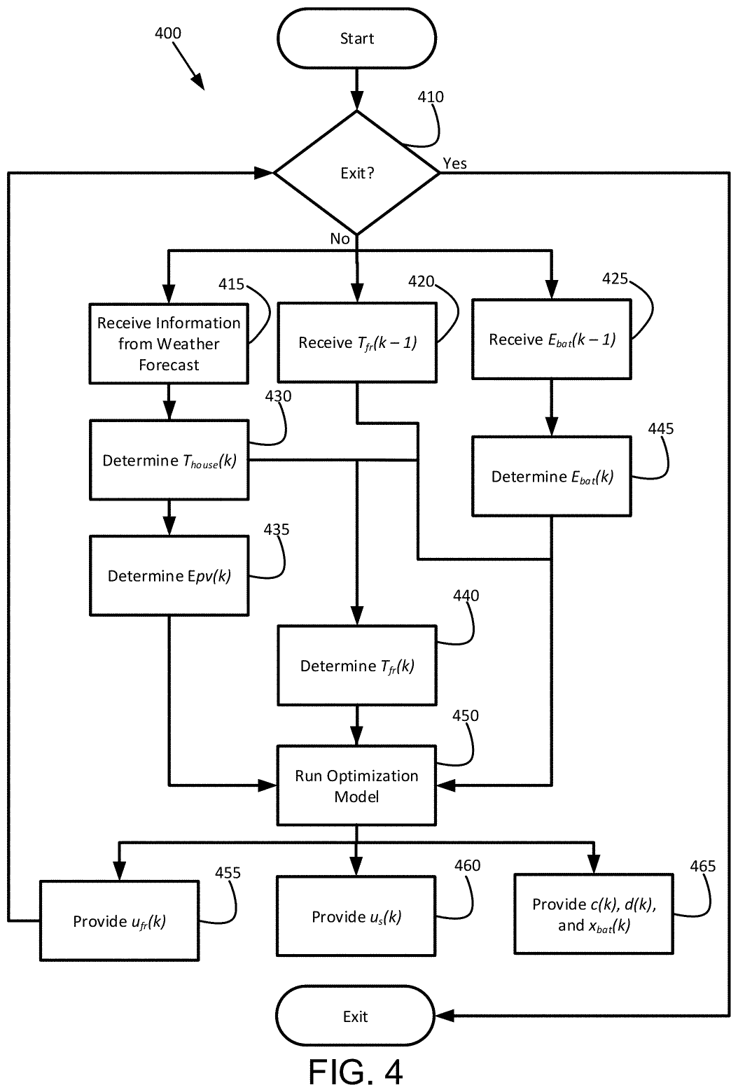

Turning now to FIG. 4, additional details are provided regarding a process 400 for optimizing energy generation and load use according to various embodiments. Here, FIG. 4 is a flow diagram showing a controller module for performing such functionality according to various embodiments of the present disclosure. For example, the flow diagram shown in FIG. 4 may correspond to operations carried out by a processing element 208 in a computing entity 200, such as the system controller 120. In various embodiments, the system controller 120 comprises means, such as processing element 208, memories 222, 224, and/or the like, for performing various operations of the process 400.

At operation 410, the system controller 120 determines whether to exit the process 400. For instance, as previously mentioned, the system controller 120 may be used for providing resiliency of a limited power supply in an environment during an outage when an external energy source is unavailable. Therefore, in particular embodiments, the system controller 120 may be configured to determine whether or not the external energy source has been restored in Operation 410. If so, then the system controller 120 may no longer be needed to regulate the energy usage of various energy loads (e.g., refrigerator 135A, fans 140A, and lights 140B) and the charging/discharging of the battery 125A, and as such, the process 400 may exit.

Otherwise, the system controller 120 may receive information for a weather forecast, the current internal temperature of the refrigerator 135A, and the current energy level of the battery 125A in Operations 415, 420, 425. Specifically, the information for a weather forecast may comprise data predicting whether for a future timepoint (e.g., timepoint k), while the current internal temperature of the refrigerator 135A and the current energy level of the battery 125A are associated with a current timepoint (e.g., timepoint k−1). As previously discussed, the weather forecast information may be a solar irradiance prediction data object 315 which may include data values 320 describing forecasted irradiance, wind speed, and the ambient air temperature.

Here, depending on the embodiment, the solar irradiance prediction data object 315 may be queried and received from any one of a number of different external sources, such as a weather service that is accessible over a network (e.g., the Internet). Meanwhile, the current internal temperature of the refrigerator 135A and the current battery level of the battery 125A may be obtained from the temperature sensor 136 and battery sensor 126 respectively. In various embodiments, the system controller 120 receives the solar irradiance prediction data object 315, the current internal temperature of the refrigerator 135A, and the current battery level of the battery 125A via network interface (e.g., transmitter 204, receiver 206). In various embodiments, the system controller 120 receives a first system state data object comprising a first primary energy load state data value 345 describing the current internal temperature of the refrigerator 135A and a first energy storage subsystem state data value 350 describing the current energy level of the battery 125A.

At operation 430, the system controller 120 determines an estimated home internal temperature. Here, in particular embodiments, the system controller 120 uses the information from the solar irradiance prediction data object 315 and the system thermal model 325 to calculate an estimated home internal temperature data value 330. At operation 435, the system controller 120 may use the estimated home internal temperature data value 330 along with the solar irradiance prediction data object 315 as input to a solar PV energy generation model 335 to calculate a solar photovoltaic energy source state data value 340 describing the maximum PV energy that will be available from the PV panels 115A. In addition, the system controller 120 then uses the first primary energy load state data value 345 describing the current refrigerator internal temperature and the estimated home internal temperature as input to a thermal dynamic model (e.g., the refrigerator thermal dynamic model previously described) to calculate, determine, and generate a second primary energy load state data value describing an estimated future refrigerator internal temperature in operation 440. At operation 445, the system controller 120 uses the first energy storage subsystem state data value 350 describing the current battery energy level as input to an energy storage model (e.g., the battery energy storage model previously described) to calculate, determine, and generate a second energy storage subsystem state data value describing an estimated future battery energy level.

At this point, the system controller 120 runs the optimization model in operation 450. Accordingly, the system controller 120 performs the optimization in the example based at least in part on the estimated home internal temperature, the solar photovoltaic energy source state data value, the second primary energy load state data value, the second energy storage subsystem state data value, and the cost function previously discussed. In various embodiments, a second system state data object may comprise the solar photovoltaic energy source state data value, the second primary energy load state data value, the second energy storage subsystem state data value, and/or the estimated home internal temperature, and the optimization is performed based at least in part on evaluating the second system state data object.

As a result of running the optimization model, control commands 360 are determined and generated. The system controller 120 provides the control command 360 for the refrigerator 135A in operation 455. In doing so, the system controller 120 causes energy to either be supplied to the refrigerator 135A or not be supplied based at least in part on the control command 360 for the refrigerator 135A. Likewise, in operation 460, the system controller 120 provides the control command 360 for the secondary energy loads 140 (e.g., fans 140A, lights 140B), thereby causing energy to either be supplied or not be supplied to the secondary energy loads 140. Similarly, in operation 465, the system controller 120 provides the control command 360 for the battery 125A, thereby causing the battery 125A to either charge at a normal charging rate, charge at a fast charging rate, or discharge.

The system controller 120 then returns to Operation 410 and determines whether to exit or not. For example, the system controller 120 determines whether an external energy source has been restored or not. If the system controller 120 determines not to exit (e.g., external energy source has not been restored), then the system controller 120 performs another iteration of the operations just discussed to determine the control commands 360 based at least in part on the current conditions being experienced with respect to the primary energy loads 135, the secondary energy loads 140 (e.g., the refrigerator 135A, fans 140A, and lights 140B) and the battery 125A. That is, the system controller 120 determines control commands 360 for a third timepoint based at least in part on conditions experienced by components of the energy system 101 at the second timepoint. Therefore, the process 400 is repeated to control the operation of the primary energy loads 135, secondary energy loads 140, and the energy storage subsystem 125, until the process 400 exits.

### IV. CONCLUSION

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the present disclosure are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for controlling at least one primary energy load, at least one secondary energy load, and an energy storage subsystem, wherein the energy storage subsystem is configured to receive energy from at least one solar photovoltaic energy source and to provide energy to the at least one primary energy load and/or the at least one secondary energy load, the computer-implemented method comprising:
receiving a first system state data object (i) associated with a first timepoint, and (ii) comprising a first primary energy load state data value and a first energy storage subsystem state data value;
receiving a solar irradiance prediction data object associated with a second timepoint subsequent to the first timepoint;
generating a second system state data object associated with a second timepoint based at least in part on the first system state data object and the solar irradiance prediction data object, the second system state data object comprising a second primary energy load state data value, a second energy storage subsystem state data value, and a solar photovoltaic energy source state data value;
determining a control command for each of the at least one primary energy load, the at least one secondary energy load, and the energy storage subsystem based at least in part on evaluating the second system state data object in an optimization model, wherein:
(i) the optimization model comprises a cost function and one or more constraints,
(ii) the one or more constraints are based at least in part on at least one objective relating to the at least one primary energy load, at least one objective relating to the at least one secondary energy load, and at least one objective relating to the energy storage subsystem, and
(iii) the control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage subsystem; and
causing energy to be supplied at the second timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

2. The computer-implemented method of claim 1, wherein:
the at least one primary energy load is configured to control an internal temperature based at least in part on being supplied with energy,
one objective relating to the at least one primary energy load is to maximize an amount of time that energy is supplied to the at least one primary energy load, and
the one or more constraints comprises a minimum allowable temperature and a maximum allowable temperature for the internal temperature of the at least one primary energy load.

3. The computer-implemented method of claim 2, wherein:
the internal temperature of the at least one primary energy load is dependent at least in part on an external temperature,
the solar irradiance prediction data object comprises an external temperature prediction data value for the second timepoint, and
the second primary energy load state data value is generated based at least in part on the external temperature prediction data value.

4. The computer-implemented method of claim 1, further comprising:
determining whether an external energy source is enabled to provide energy to the at least one primary energy load, the at least one secondary energy load, and/or the energy storage subsystem;
responsive to determining that the external energy source is not enabled to provide energy to the at least one primary energy load, the at least one secondary energy load, and/or the energy storage subsystem, generating a third system state data object associated with a third timepoint;
determining a control command for each of the at least one primary energy load, the at least one secondary energy load, and the energy storage subsystem based at least in part on evaluating the third system state data object in the optimization model; and
causing energy to be supplied at the third timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

5. The computer-implemented method of claim 4, wherein the amount of time between the first timepoint and the second timepoint is substantially equal to the amount of time between the second timepoint and the third timepoint.

6. The computer-implemented method of claim 1, wherein the optimization model comprises a mixed integer linear program (MTLP), and each of the control commands for the at least one primary energy load and the at least one secondary energy load is an integer value indicating whether or not to supply energy to a respective one of the at least one primary energy load or the at least one secondary energy load.

7. The computer-implemented method of claim 1, wherein an objective for the energy storage subsystem is to charge the energy storage subsystem with an energy amount enabling the energy storage subsystem to provide energy at the second timepoint to at least one of (i) the at least one primary energy load, and (ii) the at least one secondary energy load.

8. The computer-implemented method of claim 1, wherein the one or more constraints comprises a maximum energy amount available from the at least one solar photovoltaic energy source, the maximum energy amount determined based at least in part on the solar irradiance prediction data object.

9. An apparatus comprising at least one processor and at least one memory comprising computer program code, the at least one memory and the computer program code configured to, with the at least one processor, cause the apparatus to:
receive a first system state data object (i) associated with a first timepoint, and (ii) comprising a first primary energy load state data value and a first energy storage subsystem state data value, wherein the first system state data object is configured to describe an energy system comprising at least one primary energy load, at least one secondary energy load, and an energy storage subsystem configured to receive energy from at least one solar photovoltaic energy source and to provide energy to the at least one primary energy load and/or the at least one secondary energy load;
receive a solar irradiance prediction data object associated with a second timepoint subsequent to the first timepoint;
generate a second system state data object associated with a second timepoint based at least in part on the first system state data object and the solar irradiance prediction data object, the second system state data object comprising a second primary energy load state data value, a second energy storage subsystem state data value, and a solar photovoltaic energy source state data value;
determine a control command for each of the at least one primary energy load, the at least one secondary energy load, and the energy storage subsystem based at least in part on evaluating the second system state data object in an optimization model, wherein:
(i) the optimization model comprises a cost function and one or more constraints,
(ii) the one or more constraints are based at least in part on at least one objective relating to the at least one primary energy load, at least one objective relating to the at least one secondary energy load, and at least one objective relating to the energy storage subsystem, and
(iii) the control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage subsystem; and
causing energy to be supplied at the second timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

10. The apparatus of claim 9, wherein:
the at least one primary energy load is configured to control an internal temperature based at least in part on being supplied with energy,
one objective relating to the at least one primary energy load is to maximize an amount of time that energy is supplied to the at least one primary energy load, and
the one or more constraints comprise a minimum allowable temperature and a maximum allowable temperature for the internal temperature of the at least one primary energy load.

11. The apparatus of claim 10, wherein:
the internal temperature of the at least one primary energy load is dependent at least in part on an external temperature,
the solar irradiance prediction data object comprises an external temperature prediction data value for the second timepoint, and
the second primary energy load state data value is generated based at least in part on the external temperature prediction data value.

12. The apparatus of claim 9, wherein the at least one memory and the computer program code are further configured to, with the at least one processor, cause the apparatus to:
determine whether an external energy source is enabled to provide energy to the at least one primary energy load, the at least one secondary energy load, and/or the energy storage subsystem;
responsive to determining that the external energy source is not enabled to provide energy to the at least one primary energy load, the at least one secondary energy load, and/or the energy storage subsystem, generate a third system data state object associated with a third timepoint;
determine a control command for each of the at least one primary energy load, the at least one secondary energy load, and the energy storage subsystem based at least in part on evaluating the third system state data object in the optimization model; and
cause energy to be supplied at the third timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

13. The apparatus of claim 12, wherein the amount of time between the first timepoint and the second timepoint is substantially equal to the amount of time between the second timepoint and the third timepoint.

14. The apparatus of claim 9, wherein the optimization model comprises a mixed integer linear program (MTLP), and each of the control commands for the at least one primary energy load and the at least one secondary energy load is an integer value indicating whether or not to supply energy to a respective one of the at least one primary energy load or the at least one secondary energy load.

15. The apparatus of claim 9, wherein an objective for the energy storage subsystem is to charge the energy storage subsystem with an energy amount enabling the energy storage subsystem to provide energy at the second timepoint to at least one of (i) the at least one primary energy load, and (ii) the at least one secondary energy load.

16. The apparatus of claim 9, wherein the one or more constraints comprises a maximum energy amount available from the at least one solar photovoltaic energy source, the maximum energy amount determined based at least in part on the solar irradiance prediction data object.

17. A computer program product comprising at least one computer-readable storage medium having computer-readable program code portions stored therein, the computer-readable program code portions including executable portions configured to cause a processor to:
receive a first system state data object (i) associated with a first timepoint, and (ii) comprising a first primary energy load state data value and a first energy storage subsystem state data value, wherein the first system state data object is configured to describe an energy system comprising at least one primary energy load, at least one secondary energy load, and an energy storage subsystem configured to receive energy from at least one solar photovoltaic energy source and to provide energy to the at least one primary energy load and/or the at least one secondary energy load;
receive a solar irradiance prediction data object associated with a second timepoint subsequent to the first timepoint;
generate a second system state data object associated with a second timepoint based at least in part on the first system state data object and the solar irradiance prediction data object, the second system state data object comprising a second primary energy load state data value, a second energy storage subsystem state data value, and a solar photovoltaic energy source state data value;
determine a control command for each of the at least one primary energy load, the at least one secondary energy load, and the energy storage subsystem based at least in part on evaluating the second system state data object in an optimization model, wherein:
(i) the optimization model comprises a cost function and one or more constraints,
(ii) the one or more constraints are based at least in part on at least one objective relating to the at least one primary energy load, at least one objective relating to the at least one secondary energy load, and at least one objective relating to the energy storage subsystem, and
(iii) the control command for the energy storage subsystem is a command for one of (a) charging the energy storage subsystem at a first charging rate via the at least one solar photovoltaic energy source, (b) charging the energy storage subsystem at a second charging rate via the at least one solar photovoltaic energy source, or (c) discharging the energy storage subsystem; and
causing energy to be supplied at the second timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

18. The computer program product of claim 17, wherein:
the at least one primary energy load is configured to control an internal temperature based at least in part on being supplied with energy,
one objective relating to the at least one primary energy load is to maximize an amount of time that energy is supplied to the at least one primary energy load, and
the one or more constraints comprise a minimum allowable temperature and a maximum allowable temperature for the internal temperature of the at least one primary energy load.

19. The computer program product of claim 17, wherein the computer-readable program code portions further comprise executable portions configured to cause a processor to:
determine whether an external energy source is enabled to provide energy to the at least one primary energy load, the at least one secondary energy load, and/or the energy storage subsystem;
responsive to determining that the external energy source is not enabled to provide energy to the at least one primary energy load, the at least one secondary energy load, and/or the energy storage subsystem, generate a third system data state object associated with a third timepoint;
determine a control command for each of the at least one primary energy load, the at least one secondary energy load, and the energy storage subsystem based at least in part on evaluating the third system state data object in the optimization model; and
cause energy to be supplied at the third timepoint to at least one of (i) the at least one primary energy load from the energy storage subsystem, (ii) the at least one secondary energy load from the energy storage subsystem, or (iii) the energy storage subsystem from the at least one solar photovoltaic energy source based at least in part on each of the determined control commands.

20. The computer program product of claim 17, wherein the optimization model comprises a mixed integer linear program (MTLP), and each of the control commands for the at least one primary energy load and the at least one secondary energy load is an integer value indicating whether or not to supply energy to a respective one of the at least one primary energy load or the at least one secondary energy load.
